(19) United States
(12) Patent Application Publication
(10) Pub. No.: US 2005/0129910 A1
(43) Pub. Date: Jun. 16, 2005

(54) Grip belt and its fabrication method

(76) Inventor: Chun-Fu Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/734,537

(22) Filed: Dec. 12, 2003

(51) Int. Cl. B32B 3/10

(52) U.S. Cl. 428/139; 428/138

(57) ABSTRACT

A grip belt having a nonwoven fabric base material, which has through holes through the top and bottom surfaces, an elastic polyurethane cover layer bonded to the top surface of the nonwoven fabric base material and filled up the through holes, a plurality of small air holes formed in the elastic polyurethane cover layer adjacent to the nonwoven fabric base material, and a plurality of air cells formed in the elastic polyurethane cover layer within and around the through holes.

### BACKGROUND OF THE INVENTION

1. Field of the Invention

The present invention relates to a grip belt for binding on the grip of a device and, more particularly, to such a grip belt, which has air cells formed in the polyurethane cover layer to enhance the shock-absorbing power of the grip belt. The invention relates also to the fabrication of such a grip belt.

2. Description of the Related Art

A conventional grip belt (see FIG. 1) is generally comprised of a layer of nonwoven fabric and a layer of polyurethane-based elastic material. During fabrication, polyurethane and dimethyl foramide are mixed subject to the ratio of 1:0.8˜1:0.9, and then the mixture is added with pigment and surface active agent. After well mixed, the final mixture is applied to a wet nonwoven fabric (of humility about 20˜22%), and then the nonwoven fabric is put in a water bath for treatment to dissolve dimethyl foramide, thereby causing small air holes to be formed in the coating of the nonwoven fabric. After removal of dimethyl foramide from polyurethane, polyurethane is hardened. The workpiece is then taken out of the water bath and then dried with hot air, and therefore the polyurethane layer is bonded to the nonwoven fabric.

The elastic layer of the aforesaid grip belt has a smooth surface before further treatment, and the grip belt is slippery. The presence of aforesaid small air holes makes the elastic layer compressible. However, because the air holes are too small, the elastic effect is not significant. For positive gripping of the hand, the surface of the slippery elastic layer must be further treated. Further, in order to enhance the elasticity of the grip belt, punch holes are made through the elastic layer and the nonwoven fabric layer. These added processing processes complicate the fabrication time and cost of the grip belt.

### SUMMARY OF THE INVENTION

The present invention has been accomplished under the circumstances in view. It is the main object of the present invention to provide a grip belt, which has air cells formed in the elastic polyurethane cover layer during the formation of the elastic polyurethane cover layer on the nonwoven fabric base layer, enhancing the shock-absorbing power of the grip belt. It is another object of the present invention to provide a grip belt, which has tiny recessed portions formed in the surface of the elastic polyurethane cover layer during the formation of the elastic polyurethane cover layer on the nonwoven fabric base layer, enhancing the anti-skid power of the grip belt.

To achieve these and other objects of the present invention, the grip belt comprises a nonwoven fabric base material, which has through holes through the top and bottom surfaces, an elastic polyurethane cover layer bonded to the top surface of the nonwoven fabric base material and filled up the through holes, a plurality of small air holes formed in the elastic polyurethane cover layer adjacent to the nonwoven fabric base material, and a plurality of air cells formed in the elastic polyurethane cover layer within and around the through holes. The grip belt fabrication method comprises the steps of 1) preparing a nonwoven fabric base material having through holes through top and bottom surfaces thereof; 2) wetting the nonwoven fabric base material; 3) preparing a coating mixture from polyurethane and dimethyl foramide and then applying the coating mixture to the top surface of the nonwoven fabric base material to fill up the through holes; 4) putting the coating mixture-coated nonwoven fabric base material in a water bath to dissolve dimethyl foramide from the coating mixture, for enabling air cells to form in the coating mixture; and 5) drying the coating mixture-coated nonwoven fabric base with hot air so as to obtain the finished product.

### BRIEF DESCRIPTION OF THE DRAWINGS

FIG. 1 is a sectional view of a grip belt according to the prior art.

FIG. 2 is a sectional elevation of a nonwoven fabric base material for a grip belt according to the present invention.

FIG. 3 is a schematic drawing showing a PU-and-DMF mixture covered on the nonwoven fabric base material according to the present invention.

FIG. 4 is an enlarged view of a part of the grip belt according to the present invention.

FIG. 5 is a schematic drawing showing the grip belt compressed according to the present invention.

FIG. 6 is an applied view of the present invention, showing the grip belt wound round an elastic sleeve member.

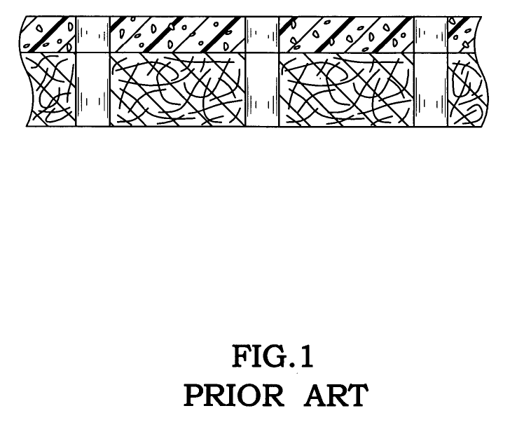

### DETAILED DESCRIPTION OF THE PREFERRED EMBODIMENT

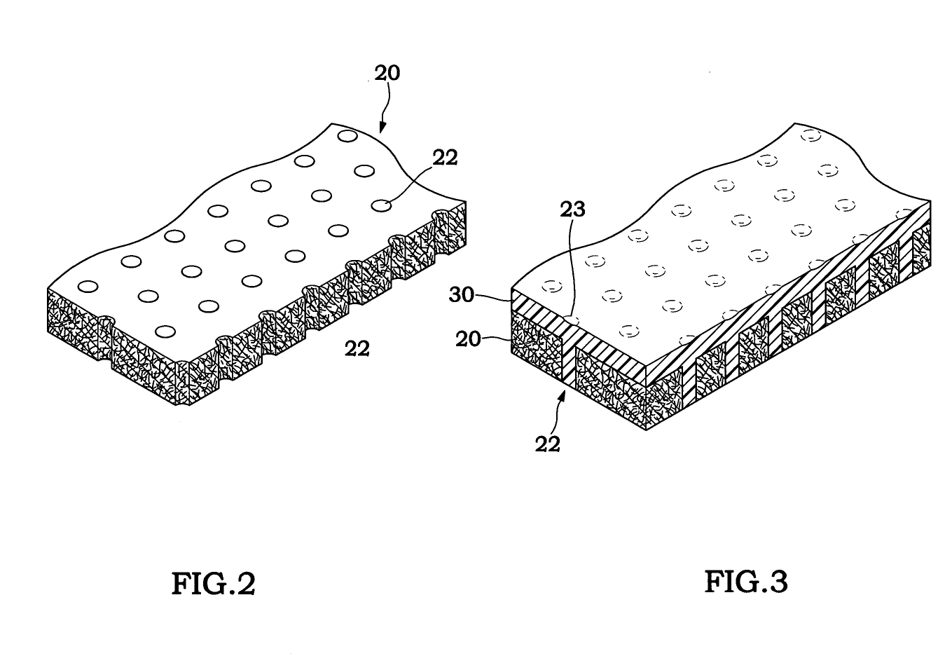

Referring to FIG. 2, a grip belt in accordance with the present invention comprises a nonwoven fabric base material 20. The nonwoven fabric base material 20 has a plurality of through holes 22 through the top and bottom sides. The through holes 22 may be formed in the nonwoven fabric base material 20 orderly or disorderly as desired.

Referring to FIG. 3, the nonwoven fabric base material 20 is wetted (to humility about 26˜30%), and then PU (polyurethane) and DMF (dimethyl foramide) are mixed subject to the ratio of 1:0.8˜1:0.9, and then added with pigment and surface active agent, and then the mixture is applied to the wet nonwoven fabric base material, for enabling the mixture to fill in the through holes 22 and to form a plurality of recessed portions 23 corresponding to the through holes 22.

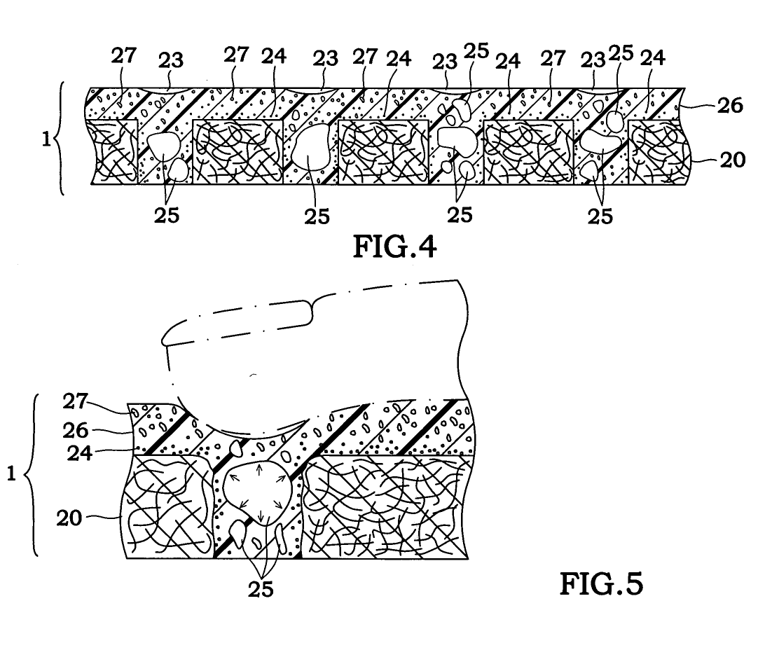

Referring to FIGS. 3 and 4, because the nonwoven fabric base material contains moisture, DMF in the coating material 30 contacting the nonwoven fabric base material starts to dissolve at a slow speed, thereby causing a plurality of tiny air holes 24 to be formed in the coating material 30 around the nonwoven fabric base material.

The workpiece, i.e., the combination of the nonwoven fabric base material 20 and the coating material 30 is put in a water bath for treatment. During bathing, DMF is rapidly dissolved in water, thereby causing big-size air cells 25 and medium-size air cells 27 to form in the coating material 30 in areas corresponding to the through holes 22 and close to the top surface of the coating material 30. After drying with hot air, PU is hardened, and therefore an elastic PU cover layer 26 is formed on the nonwoven fabric base material 20. As illustrated, the elastic PU cover layer 26 has tiny air holes 24 in the area close to the nonwoven fabric base material 20, and big-size air cells 25 and medium-size air cells 27 in the top surface area, the through holes 22 of the nonwoven fabric base material 20 as well as the area around the through holes 22 and close to the n elastic PU cover layer 26.

The reason of the formation of the big-size air cells 25 is explained hereinafter. According to the conventional method, the nonwoven fabric is not punched to provide through holes, and DMF is dissolved in water after putting of the mixture-coated workpiece in the water bath. Although the whole workpiece was put in the water bath, the isolation effect of the nonwoven fabric limits the exchange area between water and DMF to the surface of the coating, and water passes to the deep side of the coating through the top surface of the coating slowly, and therefore only small air holes are formed in the coating of the workpiece. Therefore, air cells cannot be formed in the workpiece according to the conventional method. According to the present invention, the nonwoven fabric base material 20 has through holes 22 through the top and bottom sides. After coating, the coating material 30 fills in the through holes 22 of the nonwoven fabric base material 20.Therefore, when put the workpiece in the water bath, water permeates the coating material 30 from the top side of the coating material 30 and the through holes 22 of the nonwoven fabric base material 20, thereby causing DMF to be dissolved rapidly from two sides, and therefore big-size air cells 25 are formed in the workpiece.

As illustrated in FIG. 5, the grip belt 1 has big-size air cells 25 and tiny recessed portions 23. When compressed the grip belt 1, the air cells 25 buffer the pressure. Further, the tiny recessed portions 23 enhance anti-skid effect of the grip belt 1.

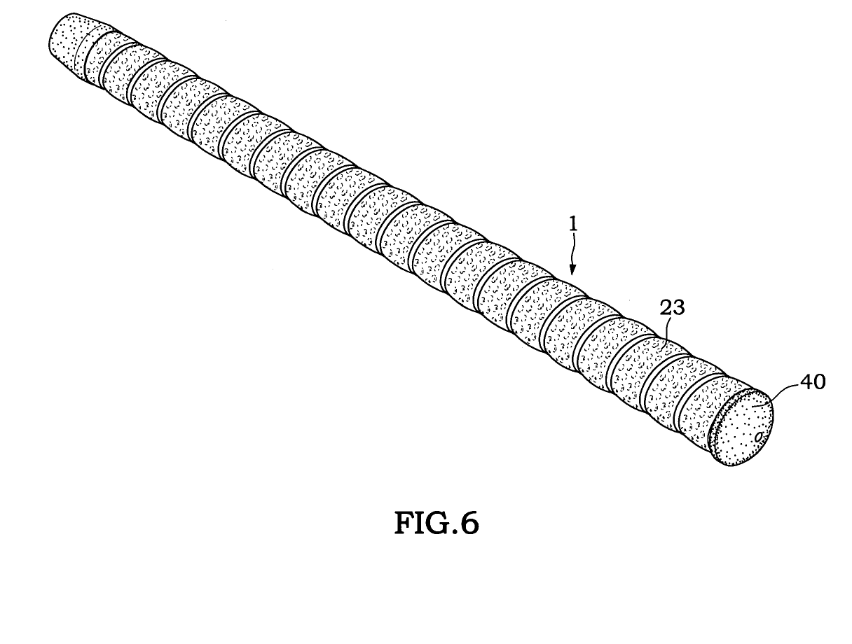

FIG. 6 shows the grip belt 1 wound round an elastic sleeve member 40.

As indicated above, the invention provides a grip belt, which comprises a nonwoven fabric base material and an elastic PU cover material bonded to the nonwoven fabric base material. The elastic PU cover material has big-size air cells and medium-size air cells to buffer shocks, and tiny recessed portions in the top surface to enhance the anti-skid effect.

A prototype of grip belt has been constructed with the features of FIGS. 2˜5. The grip belt functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A grip belt comprising:
a nonwoven fabric base material, said nonwoven fabric base material having a plurality of through holes through top and bottom sides thereof;
an elastic polyurethane cover layer bonded to the top side of said nonwoven fabric base material and filled up the through holes of said nonwoven fabric base material;
a plurality of small air holes formed in said elastic polyurethane cover layer adjacent to said nonwoven fabric base material; and
a plurality of air cells formed in said elastic polyurethane cover layer within and around said through holes.

2. The grip belt as claimed in claim 1 further comprising a plurality of recessed portions formed in one side of said elastic polyurethane cover layer opposite to said nonwoven fabric base material corresponding to said through holes.

3. The grip belt as claimed in claim 1, wherein said through holes are formed in said nonwoven fabric base material subject to a predetermined pattern.

4. A grip belt fabrication method comprising the steps of:
1) preparing a nonwoven fabric base material having through holes through top and bottom surfaces thereof;
2) wetting said nonwoven fabric base material;
3) preparing a coating mixture from polyurethane and dimethyl foramide and then applying said coating mixture to the top surface of said nonwoven fabric base material to fill up said through holes;
4) putting the coating mixture-coated nonwoven fabric base material in a water bath to dissolve dimethyl foramide from said coating mixture, for enabling air cells to form in said coating mixture; and
5) drying the coating mixture-coated nonwoven fabric base with hot air so as to obtain the finished product.

5. The grip belt fabrication method as claimed in claim 4, wherein said coating mixture is covered on the top surface of said nonwoven fabric base material to fill up said through holes in such a manner that recessed portions are formed in an outer surface of said coating mixture corresponding to said through holes.

6. The grip belt fabrication method as claimed in claim 4, wherein said through holes are formed in said nonwoven fabric base material subject to a predetermined pattern.

7. The grip belt fabrication method as claimed in claim 4, wherein said nonwoven fabric base material is wetted to the status having the humility about 26˜30%.

8. The grip belt fabrication method as claimed in claim 4, wherein said air cells are formed in said coating mixture within and around said through holes.
